(19) United States
(12) Patent Application Publication
(10) Pub. No.: US 2005/0275217 A1
(43) Pub. Date: Dec. 15, 2005

(54) Mechanical joint gripping gasket

(75) Inventors: Van T. Walworth, Lebanon, TN (US); David B. Hook, Franklin, TN (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: Star Pipe Products Ltd.

(21) Appl. No.: 11/130,968

(22) Filed: May 17, 2005

Related U.S. Application Data
(63) Continuation-in-part of application No. 10/817,674, filed on Apr. 2, 2004.

(51) Int. Cl. F16L 17/00

(52) U.S. Cl. 285/110

(57) ABSTRACT

A novel gasket includes at least one gripping element embedded in an annular member for forming a seal between two tubulars. For tubulars having socket and spigot ends, the gripping element includes teeth for gripping an outer surface of the spigot end and a blunt nose for contacting a front wall of a gland that compresses the gasket against surfaces of the socket and spigot ends. The blunt nose rolls along the front wall of the gland during relative movement between the tubulars and can include a contacting face of a specialized geometry to adjust contact dynamics and/or roughened surfaces to increase the frictional contact between the blunt nose and the front wall. The gripping elements can also include at least four teeth arranged such that no more than two teeth normally grip the outer surface of the spigot end. One or more teeth can also include a transverse groove to enhance penetration into the outer surface of the spigot end.

### CROSS-REFERENCE TO RELATED APPLICATIONS

This is a continuation-in-part of U.S. patent application Ser. No. 10/817,674, filed Apr. 2, 2004.

### BACKGROUND OF THE INVENTION

1. Field of the Invention

This invention relates to devices for locking joints for tubular members. More particularly, the present invention relates to gaskets for sealing and locking a socket end of one tubular to a spigot end of another tubular.

2. Description of the Prior Art

Pipes joined in telescoping relationship typically have a spigot end of one pipe inserted into the socket end of the engaging pipe. The socket end has an opening large enough to receive the spigot end of the enclosed pipe. A gasket is inserted in the socket end of the enclosing pipe and prevents leakage of fluid from the joint by forming a seal between the two pipes. In many applications, a fluid under pressure flows through the pipes. This fluid pressure can produce a separating force, known as joint separating end thrust, that can cause the pipes to separate at the joint.

A common device for coupling two pipes is a mechanical joint.” A mechanical joint typically includes a flange or annular ring arrangement to compress a gasket into sealing engagement between a spigot end of one pipe and a socket end of another pipe. Under the compressive force of fastening elements such as bolts, the gasket deforms into sealing contact with outer surface of the spigot end and the inner surface of the socket end.

Another method of locking the joint between two pipes involves configuring as sealing gasket as a restraining mechanism. For example, a resilient sealing gasket can be provided with a number of circumferentially spaced apart metal inserts. These metal inserts include teeth that are adapted to penetrate an outer surface of a pipe spigot end. Upon installation, the teeth bite into the pipe spigot end to prevent the pipe spigot end from sliding out of the socket end.

As is known, the dimensions of the pipe spigot and socket ends, while conforming to industry standards, can vary during manufacture. The ability of the gasket to seal and lock the joint, however, can be adversely affected by such dimensional variations. Thus, there is a persistent need for sealing and restraining gaskets that can accommodate pipes having such dimensional variations. Moreover, there is a persistent need for gaskets that lock or retain a joint without unduly compromising the structure of the pipe (e.g., excessive penetration). The present invention addresses these and other needs of the prior art.

### SUMMARY OF THE INVENTION

In one aspect, the present invention provides a retention and sealing device for mechanical joints between tubulars. In one embodiment, the sealing device is a gasket is used to join a first tubular having a socket end with a second tubular having a spigot end. The gasket is compressed within the joint by a gland that is connected by fasteners to the socket end. The exemplary device includes a resilient annular member having a sealing portion for forming a seal between the first tubular and the second tubular and at least one gripping element positioned in the resilient member. The gripping element includes a plurality of teeth projecting radially inward relative to the socket for gripping an outer surface of the spigot end and a blunt nose extending axially forward relative to the socket for contacting a front wall of the gland. The gripping element can also include wings extending from the gripping element that enhance stability and effectiveness of the gripping element and a radially outward knob that limits the radial travel of the blunt nose. The blunt nose adapted to contact and roll along the front wall during relative movement between the first and second tubulars. The terms radially inward(ly) and radially outward(ly) are used with reference to the axial centerline of the tubulars (i.e., meaning pointing toward or away from the tubular centerline, respectively). The terms axially forward refers to a direction toward the end of the tubular and term axially rearward refers to a direction toward the middle of the tubular.

In one embodiment, the gripping elements seat within pockets pre-formed in the resilient body and include one or more extrusion reliefs formed on the outer surface of the wings. The extrusion reliefs are voids into which the material making up the resilient body can flow during compression. In certain embodiments, the blunt nose can include features and elements for enhancing the rolling contact between the blunt nose and the front wall of the socket end. For instance, the blunt nose can have a contacting face of a specialized geometry (e.g. convex, concave, flat, etc.) to selectively adjust the location of initial contact, contact pressure, or other parameter (e.g., contact dynamics). Additionally, a roughened surface on the blunt nose can be used to increase the frictional contact between the blunt nose and the front wall. Suitable roughness can be obtained by using an irregular surface formed by grit blasting, chemical etches, spline protrusions, knurled protrusions, impregnated grit, composite constructions, bonded elements, and coated elements.

In embodiments, the gripping element can also include arrangements to enhance the locking function provided by the gripping elements, facilitate assembly, improve product life and improve performance, etc. For instance, the gripping element can include least four teeth arranged such that no more than two teeth grip the outer surface of the spigot end when the spigot end is inserted into the socket end. For instance, at least three can lie along a common arc. Additionally, the gripping element can include a ridge extending radially outwardly from the gripping element to limit the movement of the blunt nose along the front face. In certain embodiments, at least one tooth includes a transverse groove that enhances the tooth's ability to penetrate into the outer surface of the spigot.

It should be understood that examples of the more important features of the invention have been summarized rather broadly in order that detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWING

Other objects and advantages of the present invention will become apparent to those skilled in the art from the following description of the invention taken in conjunction with the accompanying drawing in which like numerals indicate like elements and in which:

FIG. 1 illustrates a cross-sectional view of a jointed between an enclosing pipe and a mating pipe that uses a gasket made in accordance with one embodiment of the present invention;

FIG. 2 illustrates an end view of a gasket made in accordance with one embodiment of the present invention;

FIG. 3 illustrates a methodology for arranging inwardly projecting teeth according to one embodiment of the present invention;

FIG. 4 illustrates the motion of a gasket insert made in accordance with one embodiment of the present invention during use;

FIG. 5 illustrates an isometric view of a gasket insert made in accordance with one embodiment of the present invention;

FIG. 6 illustrates a typical mechanical joint provided with a gasket made according to one embodiment of the present invention;

FIG. 7 illustrates a sectional view of a gasket and insert made in accordance with one embodiment of the present invention;

FIG. 8 illustrates an isometric view of a gasket insert made in accordance with one embodiment of the present invention;

FIG. 9 illustrates an end view of a gasket made according to one embodiment of the present invention; and

FIG. 10 illustrates a sectional view of the FIG. 9 embodiment.

### DESCRIPTION OF THE PREFERRED EMBODIMENT

The present invention relates to devices and methods providing robust and cost-effective gasket arrangements for pipe joints. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein. As used herein, the terms radially inward(ly) and radially outward(ly) are used with reference to the axial centerline of the tubulars (i.e., meaning pointing toward or away from the tubular centerline). The terms axially forward means in a direction toward the end of the tubular and term axially rearward means in a direction toward the middle of the tubular. Further, no particular geometry, material, or other technical limitation is implied by the term “gasket.” Rather, as used herein, this term merely refers to An apparatus for providing at least a seal at a discontinuity in a flow path of a fluid.

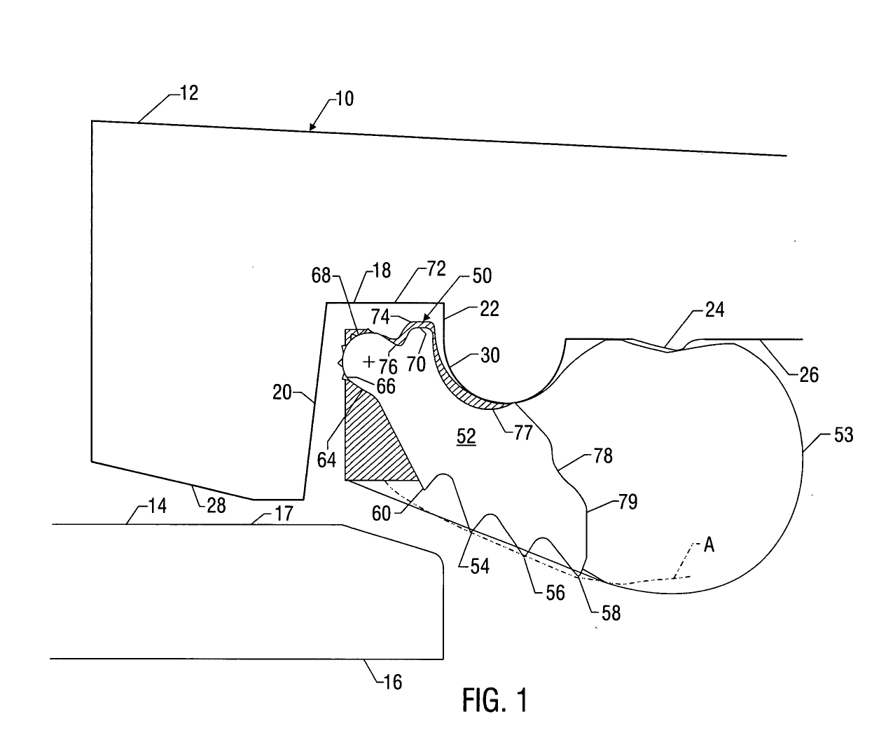

Referring now to FIG. 1, there is shown a joint formed by a first enclosing pipe 10 having a bell end 12 and second pipe 14 having a spigot end 16. To make up a joint, the second pipe 14 is pushed into the bell end 12 of the enclosing pipe 10. Conventionally, the inner surface of pipe bell end 12 has a retainer groove 18 bounded by a front wall 20, a retainer wall 22, a circumferential compression rib 24 that projects radially inwardly from a sealing wall 26, and a throat portion 28 that terminates at the front wall 20. Moreover, the inner surface can also include a shoulder 30 formed adjacent the retainer wall 22.

A gasket 50 made in accordance with one embodiment of the present invention locks together the pipes 10 and 14 and also provides a fluid seal at the joint. As will become apparent, the gasket 50 includes elements and features that co-act with the pipes 10 and 14 in a manner that preserves the integrity of the joint by accommodating relative motion between the pipes 10 and 14.

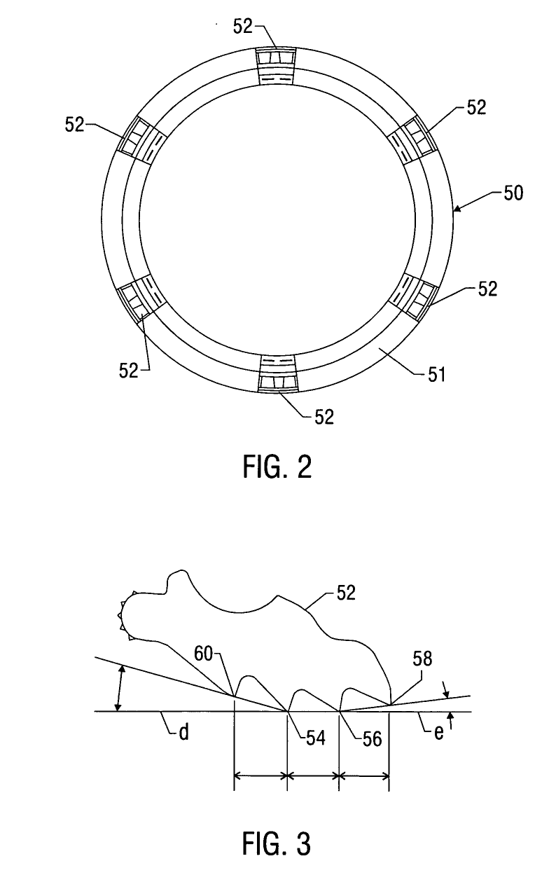

Referring now to FIGS. 1 and 2, in one embodiment the gasket 50 includes a resilient body 51 provided with a plurality of relatively hard segments 52. The segments 52, which can be formed of a suitable metal, are circumferentially arrayed in a spaced-apart fashion within the body of the gasket.50. In one embodiment, the segments 52 are firmly vulcanized into radial grooves in gasket 50. The segment 52 can also be embedded into the gasket by bonding, encapsulation, over-molding, mechanical cooperation, or by one of many other suitable methods. The number of segments 52 inserted into the gasket 50 can vary depending upon the anticipated fluid pressure at the joint and the size of the pipes involved. The segments 52 can be suitably machined, investment cast, extruded, forged, or by other suitable manufacturing methods. The segment 52 can include one or more features for enhancing the integrity of the joint between pipes 10 and 14. While the features are described below as being provided on one segment 52, it should be understood that each feature can be utilized separately as well as in conjunction with one another.

In one embodiment, the segment 52 has three teeth 54, 56 and 58 pointed radially inwardly such that the teeth 54, 56 and 58 can bite into an outer surface of the spigot end 16 when the spigot end 16 is inserted into the pipe bell end 12. The segment 52 can include a fourth tooth 60 also adapted to bite into the outer surface of the spigot end 16. The teeth 54-60 can be equally spaced or asymmetrically spaced relative to one another. Merely for convenience, the three teeth 54, 56 and 58 will be referred to as rearwardly positioned and the fourth tooth 60 will be referred to as forwardly positioned. In one embodiment, the forward tooth 60 will be located “inside” a circle described by the common arc A of the three rearward teeth 54-58. It is believed that positioning the forward tooth 60 “inside” the boundary of the common arc, or relatively “removed” away from the spigot 16, can reduce the insertion force required to assemble the joint. It will be appreciated that when a plurality of teeth are arranged along a common arc, only two teeth can contact a flat surface at any given time (of course, excluding factors such as teeth penetration and deformation). In some embodiments, more than four teeth can be used. In such embodiments, each subsequent forwardly positioned tooth would also be located inside the common arc of the rearwardly positioned teeth such that each subsequent forward tooth would be more removed from the spigot than the preceding tooth.

Referring now to FIG. 3, another method of defining the relative positioning of four (or more) teeth 54-60 is to consider orienting the segment 52 such that a line can be drawn between the two middle teeth 56, 58. A declination angle d of the forward tooth 60 is “greater” than a declination angle e of the rearward tooth 58. For instance, the angle of declination e for the rearward tooth 58 can be defined as at least 3 degrees but less than 10 degrees while the forward angle of declination d would be greater than 10 degrees but no more than about 15 degrees. Subsequent teeth rearward and/or forward would be aligned in compliance with the angles of declination defined above.

The segment 52 can also include a nose 64 projecting generally axially toward the wall 20. The nose 64 has a blunt end 66 configured to engage the wall 20. In particular, the blunt end 66 is constructed as to primarily roll on the wall 20 as opposed to biting into or sliding on the wall 20. Rolling friction between the blunt end 66 and the wall 20 can be enhanced by roughening the surface of the blunt end 66, such as by providing knurls 68 on the blunt end 66. Other methods of roughening include grit blasting, chemical etching, spline protrusions, grit impregnation, composite constructions, bonded or coated elements, etc.

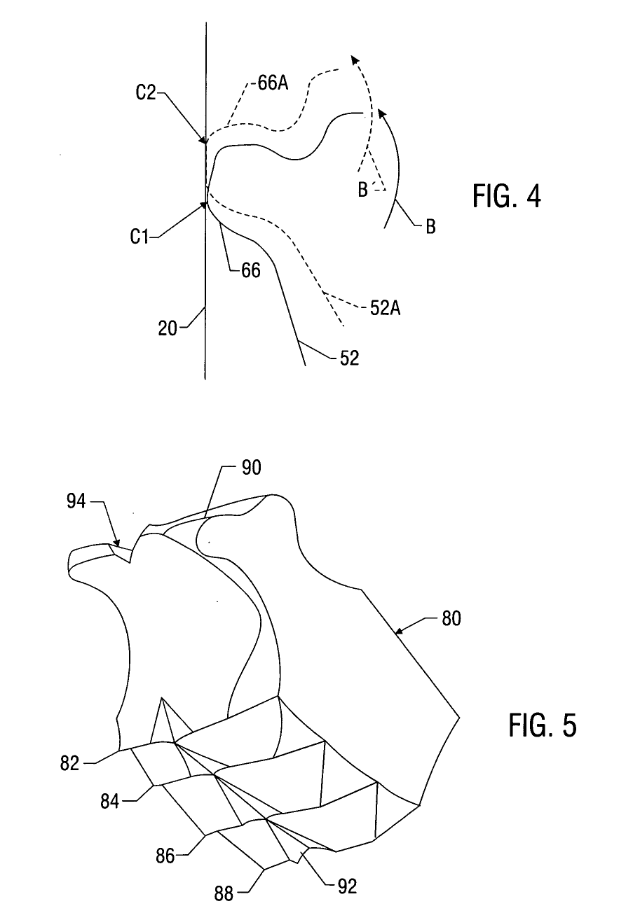

Referring now to FIGS. 1 and 4, during use, the hydraulic pressure of the fluid flowing in the pipes 10 and 14 can create a thrust force that can cause the joints to separate (joint separating end thrust). When present, the joint separating end thrust will cause the blunt nose 66 to contact the front wall 20. Once joint separating end thrust initiates contact between the blunt face and the front wall 20, the frictional interference forces are relatively static, as long as the joint separating end thrust is maintained in a static state. Frictional forces transition from static to dynamic rotational rolling forces as the segment 52 rotates (generally shown with arrow B) in response to increasing joint separating end thrust. Typically, the nose 66 of the segment 52 will have a defined contact surface area C1 with the front wall 20. Continued increasing joint separating end thrust will result in the rotation of the segment 52 as shown with arrow B. Each increment of rotation on the part of the segment 52 will result in a change in the contact surfaces between the front wall 20 and blunt nose 66. An incremental rotation is shown with segment 52A in phantom lines with an associated new contact point C2. Contact point C2 now acts as a new fulcrum or pivot point for rotation as shown by arrow B′. Thus, as the segment 52 rotates, the contact surface areas of the blunt nose 66 and the front wall 20 continually changes. Each additional increment of rotation will establish yet a new set of contact surfaces and pivot points between the blunt nose 66 and the front wall 20.

The segment 52 can also include a ridge 70 that operates as a mechanical stop to prevent excessive movement of the segment 52 during cases of extreme variations in the dimensions of the pipes 10 and 14. The blunt ridge 70 projects radially further outward than the nose 64 and ensures that the contact point between the blunt nose 60 and the front wall 20 does not migrate in such a way as to contact the most radially outward surface 72 of the socket or pipe bell end 12. The blunt ridge 70 includes resilient encapsulation 74 that provides a cushion between the blunt ridge 70 and the most radially outward surface 72 of the socket or pipe bell end 12-should they come in contact with each other. The encapsulation 74 may be confined to intermittent areas over segment 52—or be continuous around gasket OD.

In some embodiments, one or more recesses can be provided in the segment 52 to accommodate material than deforms upon the application of the forces and pressures inherent during use. For example, a recess or pocket 76 is provided between the blunt ridge 70 and the blunt nose 64. The recessed pocket 76 can be continuous or intermittent at the blunt ridge 70. In one embodiment, the volume of the recess 76 is approximately equal to the volume of the blunt ridge 70. This volumetric relationship between ridge 70 and the recess 76 gives the encapsulation 72 covering the blunt ridge 70 a place to flow into during contact—a form of void volume fill. It should be understood that fractional relationship between the volumes of the ridge 70 and the recess 76 can also be suitable in many applications. In any case, this recessed pocket 76 provides an element of flexibility and/or adjustment due to minor pipe shifting, surging, hammer, et cetera.

Also, the segment 52 further includes a scallop 78 formed on an outer rearward surface 79. Conventionally the gasket body 51 can include a sealing or bulb portion 53 that provides a fluid barrier between the pipe 10 and second pipe 14. For instance, the bulb portion 53 forms a seal between the inner wall 26 of the pipe 10 and the outer surface of the spigot end 16. The scallop 78, as will be discussed in greater detail below, can reduce the compressive forces on the bulb portion 53 and thereby reduce the risk that the bulb portion 53 bursts or otherwise fails during use.

The gasket 50 can also include a groove 77 formed on an outer circumferential diameter adjacent the ridge 70. The groove 77 is adapted to receive the shoulder 30 of the pipe bell end 12. The groove 68 is sized such that the gasket 50 can pivot at least partially around the shoulder 30 when the spigot end 16 is moving into or out of pipe bell end 12.

Referring now to FIGS. 1 and 5, there is isometrically shown another segment 80 made in accordance with one embodiment with the present invention. The segment 80 includes a plurality of teeth 82, 84, 86 and 88 and a blunt nose 90. As described earlier, the teeth 82-88 extend radially inward toward the spigot 16. The teeth 82-88 include at least one groove 92 passing through each tooth 82-88. The groove 92 is transversely oriented relative to the radially inward extending teeth 82-88. By splitting the teeth 82-88, the groove 92 provides a focused contact point between the teeth 82-88 and the spigot 16. The focused contact points allow teeth to penetrate faster and deeper into the spigot or other mating surface for any set of conditions as compared convention teeth that have a more distributed loading of pressure. The groove can be constructed from many geometric forms including half-round, dovetailed, trapezoid, square, rectangular, etc. The groove 92 also provides a haven for swaged and displaced material as teeth 82-88 bite into the spigot 16, which allows the teeth 82-88 to allow enhanced penetration. Likewise, the blunt face 90 also includes at least one groove 96 that is transversely oriented relative to the axially extending blunt face 90. The groove 94 splits the blunt face 90 and provides a focused contact point between the blunt face 90 and the front wall 20. The focused contact point provides increased frictional interference forces by focusing contact loads over a smaller surface area. The groove 94 can be constructed from many geometric forms including half-round, dovetailed, trapezoid, square, rectangular, etc. This will focus the biting penetration and provide deeper and faster penetration.

In still other embodiments, the nose can be formed as an acutely pointed tooth having at least one face or the other or both faces defining the tooth to be non-linear surfaces instead of a flat surface. The purpose of at least one non-linear surface defining the faces of the tooth results in a deeper and/or faster bite penetration of the tooth into the front wall 20 for any given set of parameters. Moreover, it should also be appreciated that the groove can be applied to a tooth designed to bite into the front wall 20. Non-linear surfaces include various convex and/or concave combinations. Non-linear surfaces include ground surfaces, hollow grounding, and various other methods of achieving arcuate convex and/or concave surfaces defining the tooth. Adjusting the geometry of the blunt nose 66 can adjust the contact points between the blunt face, adjust contact pressure, and other behavior characteristics. It should be appreciated, therefore, that the contact dynamics between the blunt nose 66 and the front wall 20 can be adjusted (e.g., optimized or otherwise controlled) by altering the geometry of the blunt nose 66.

Referring now to FIG. 1, during installation, the gasket 50 is fitted into the pipe end 12 of the enclosing pipe 10. The second pipe 14 is then inserted into the pipe end 12. As the spigot end 16 of the second pipe 14 enters the gasket 50, one or more of the teeth 54, 56 and 58 contact the outer surface of the spigot end 16. The forwardly positioned tooth 69 (if present) is recessed and, therefore, does not impede the movement of the spigot end 16 into the pipe 10. As the spigot end 16 engages the teeth 54, 56 and 58, the segment 52 rotates about the shoulder 30 such that the bulb portion 53 is squeezed between the inner surface 26 and the segment surface 79. Advantageously, the scallop 78 minimizes the stresses imposed on the gasket 50 during insertion. Undue stress on the gasket during insertion can result in unnecessarily elevated insertion force-and may dislodge the gasket. The recessed scallop reduces insertion force by reducing stress introduced to the gasket-thus reducing incidence of dislodgment and/or displacement of gasket during assembly. Further, the rotation of the segment 52 can cause one or more of the rearward teeth to disengage from the spigot end 16 and the forward tooth 60 to engage the spigot end 16. Thus, it should be appreciated that the segment 52 can be constructed such that a selected or predetermined number of teeth can be made to engage the spigot end 16 regardless of the rotational orientation of the segment 52. Once the second pipe is fully inserted into the enclosing pipe 10, installation or joint make up is substantially complete.

As noted earlier, during use or operation, the hydraulic pressure of the fluid flowing through the joint can produce joint separating end thrust that can cause the spigot end 16 to slide out of the pipe 10. This sliding action causes one or more of the teeth 54-60 to bite or penetrate into the spigot end 16. As noted earlier, the particular teeth that have engaged the spigot end 16 can depend on the rotational orientation of the segment 52. Thus, the sliding motion of the spigot end 16 draws the gasket 52 axially outward until the blunt nose 66 engages the front wall 20. The blunt 66, upon engaging the front wall 20, allows the segment 52 to rotate in a controlled manner and also modulates the radial movement of the segment 52. Also, the blunt ridge 70 engages the surface 72 during excessive radial movement of the segment 52 and thereby prevents the blunt nose 66 from riding up to the surface 72.

While the invention has been described in the environment of a pipe joint in which the bell end of the enclosing pipe has a compression rib 24, the gasket will also perform its sealing function with a bell configuration such as that shown in U.S. Pat. No. 2,953,398 which does not have a compression rib. Further, it should be understood that the teachings of the present invention can be also applied to mechanical joints other than those utilizing socket-spigot ends such as for example flanged joints. That is, the present invention may be utilized in any mechanical arrangement wherein the relative movement of two tubulars (or other fluid conduits) can compromise a fluid seal there between.

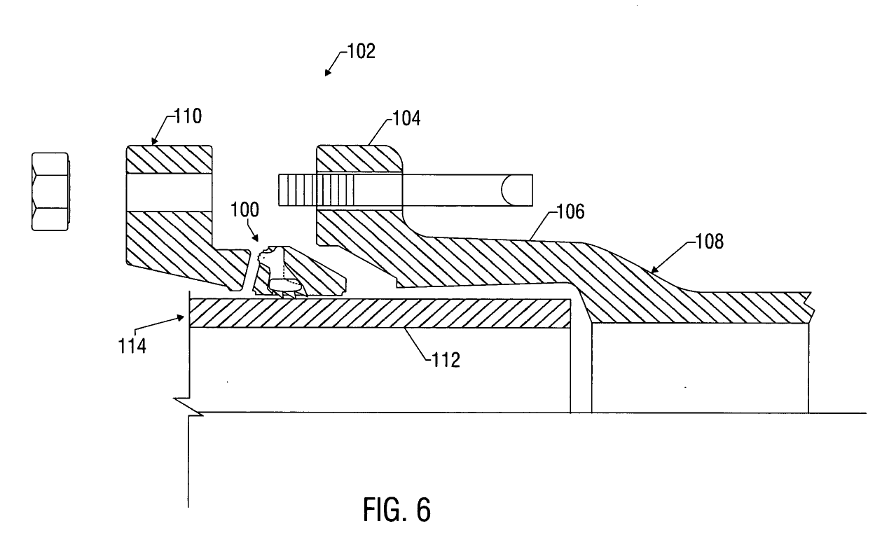

As noted above, the teachings of the present invention can be advantageously applied to flanged joints. Referring now to FIG. 6, there is shown one Illustrative embodiment of a gasket 100 in a mechanical joint 102 having a flange 104 formed on a bell end 106 of a first pipe 108 and a gland 110 for compressing the gasket 100 between a spigot end 112 of a second pipe 114 and the first pipe bell end 106. The gasket includes a ring-like sealing body 120 in which are positioned a plurality of inserts or segments 122. As will be seen, the segments 122 can include one or more features that enhance the strength and stability of the joint 102. Illustrative features include one or more teeth that mechanically engage (e.g., grip, bite, clamp, etc.) the spigot end 112 and one or more strategically positioned members that control the position of the segment relative to the bell end 106, the spigot end 112 and the gland 110. The members, which can be formed integral with the segment 122 or be separate elements fixed on the segment 122, can cooperatively or independently co-act with surfaces of the mechanical joint 102 to control the amount or degree of engagement that the teeth provide, the relative radial movement between the first pipe 108 and the second pipe 114, the relative longitudinal movement between the first pipe 108 and the second pipe 114, or aspect of the mechanical joint 102.

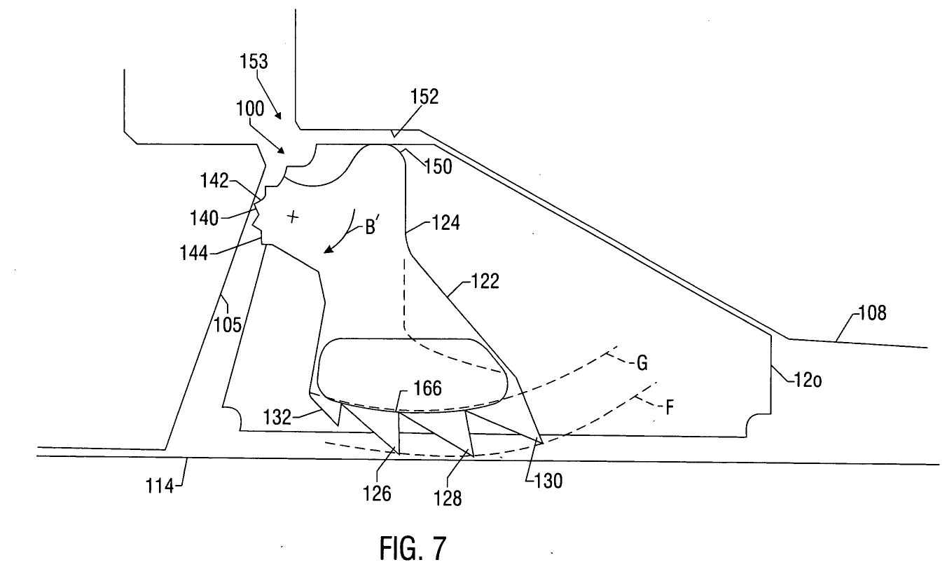

Referring now to FIG. 7, in one embodiment the gasket 100 includes a resilient body 120 provided with a plurality of relatively hard segments 122. The segments 122, which can be formed of a suitable material, are circumferentially arrayed in a spaced-apart fashion within the gasket body 120. The segment 122 can include one or more features for enhancing the integrity of the joint between pipes 108 and 114. While the features are described below as being provided on one segment 122, it should be understood that each feature can be utilized separately as well as in conjunction with one another.

In one embodiment, the segment 122 has three teeth 126, 128 and 130 pointed radially inwardly such that the teeth 126, 128 and 130 can bite into an outer surface of the spigot end 112 when the spigot end 112 is inserted into the pipe socket end 106. The segment 122 can include a fourth tooth 132 also adapted to bite into the outer surface of the spigot end 112. The teeth 126-132 can be equally spaced or asymmetrically spaced relative to one another. The function of the teeth 126-132 is generally the same as the function of teeth 54-60 as previously described. Accordingly, the shape, structure, orientation, relative positioning and function of the teeth 126-132 and their co-action with the spigot end 112 will be apparent with reference to FIGS. 1-5 and accompanying written description with the understanding that axially inward teeth 126, 128 and 130 are generally analogous to teeth 54, 56 and 58 and forward tooth 132 is generally analogous to the fourth tooth 60. As shown, teeth 126, 128 and 130 lie along an arc F.

The segment 122 includes a nose 140 projecting generally axially toward a gland wall 105 and a blunt end 142 configured to engage the wall 105. In particular, the blunt end 142 is constructed as to primarily roll on the wall 105 as opposed to biting into or sliding on the gland wall 105. Suitable shapes for the face of the nose 140 include, but are not limited to, convex, concave and flat. Rolling friction between the blunt end 142 and the wall 105 can be enhanced by roughening the surface of the blunt end 142, such as by providing knurls 144 on the blunt end 142. Other methods of roughening include grit blasting, chemical etching, spline protrusions, grit impregnation, composite constructions, bonded or coated elements, etc. Suitable materials for the segment 122 include metals, composites, and other relatively hard materials.

The segment 122 can also include a knob 150 that operates as a mechanical stop to maintain motion or movement of the segment 122 within a predefined or predetermined range during operation, during cases of extreme variations in the dimensions of the pipes 108 and 114, or other situations. The knob 150 projects radially further outward than the nose 140 and ensures that the blunt nose 140 does not migrate in such a way as to contact the inner wall surface 152 of the pipe socket end 114 or the gap 153 between the gland 110 and the socket end 114. The knob 150 can be a rounded element as shown or some other suitable shape. In other embodiments, the segment 122 itself is shaped or sized such that the blunt nose 140 cannot come into contact with the inner wall surface 152 during operation. That is, the geometry of the segment 122 can be configured that no particular protrusion or member extends from the segment 122 to act as a mechanical stop.

Referring now to FIG. 7, it should be appreciated that a triangular spatial relationship exists between the nose 140, the knob 150, and the teeth 126-132. It should also be appreciated that a different member of the joint 102 co-acts with each of these elements. That is, the nose 140 co-acts with the gland, the knob 150 co-acts with the socket end, and the teeth 126-132 co-act with the spigot end. Thus, advantageously, adjusting the relative radial and axial positions of the nose 140, the knob 150, and the teeth 126-132 can control the motion and positioning of the gland, the socket end, and the spigot end relative to one another, and can control the motion and positioning of the segment 122 relative to the gland 110, the socket end 106, and the spigot end 112. For example, reducing the relative radial distance between the knob 150 and the teeth 126-132 can increase the relative radial motion between the socket end and the spigot end.

Referring now to FIGS. 6 and 7, during use, the hydraulic pressure of the fluid flowing in the pipes 108 and 114 can create a thrust force that can cause the joints to separate (joint separating end thrust). When present, the joint separating end thrust will cause the blunt nose 140 to contact the wall 105. Once joint separating end thrust initiates contact between the blunt nose 140 and the gland wall 105, the frictional interference forces are relatively static, as long as the joint separating end thrust is maintained in a static state. Frictional forces transition from static to dynamic rotational rolling forces as the segment 122 rotates (generally shown with arrow B′) in response to increasing joint separating end thrust. Typically, the nose 140 of the segment 122 will have a defined contact surface area with the gland wall 105. Continued increasing joint separating end thrust will result in the rotation of the segment 122 as shown with arrow B′. Each increment of rotation on the part of the segment 122 will result in a change in the contact surfaces between the gland wall 105 and blunt nose 140. Thus, as the segment 122 rotates, the contact surface areas of the blunt nose 140 and the gland wall 105 continually changes. Each additional increment of rotation will establish yet a new set of contact surfaces and pivot points between the blunt nose 140 and the gland wall 105. Generally speaking, the nose 140 provide a pivot point or center of rotation that allows the segment 122 to rotate clockwise or counter clockwise during assembly and during use.

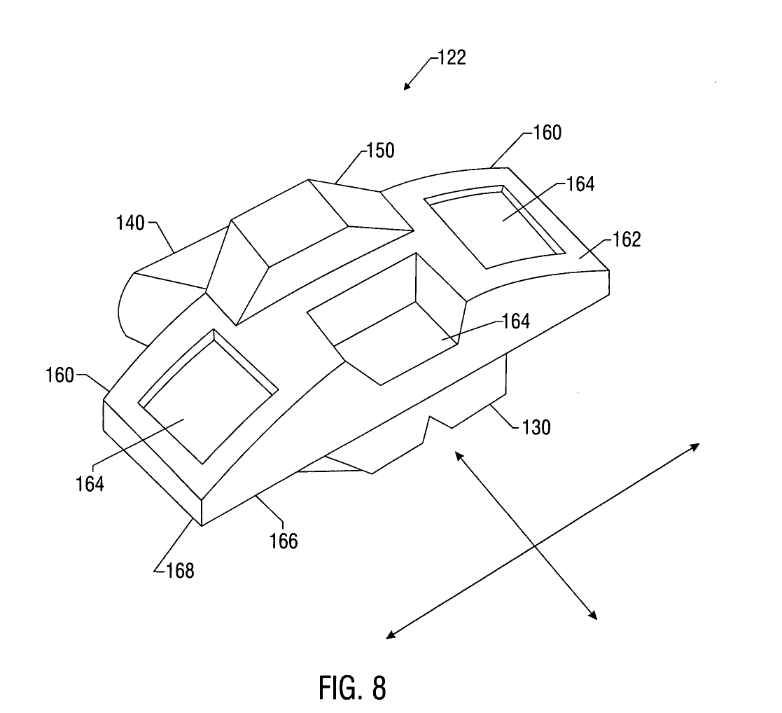

Referring now to FIG. 8, there is isometrically shown another embodiment of a segment 122 having a blunt nose 140, a knob 150 and a plurality of teeth (representative tooth 130 being shown). The segment 122 includes stabilization elements 160 that can stabilize the motion of the segment 122 and control the co-action of the segments 122 vis-a-vis the gasket body 120 (FIG. 7) and the joint (i.e., the gland and the spigot end). In one arrangement, the stabilization elements 160 are formed as tabs or shoulders that extend out of the segment 122 in a direction generally transverse to the longitudinal axis of the pipe, labeled as L. The shape of the stabilization tabs 160 can be configured to influence one or more aspects of the function, operation, and/or behavior of the segment 122. For example, the surfaces of the stabilization tabs 160, such as radially outer surface 162, can include one or more holes, recesses or cavities 164. These recesses 164 are void areas into which gasket body material can flow or extrude into when the gland 110 compresses the gasket body 120 against the spigot end 106 and the socket end 114. Further, one or more radially inward surfaces, such as surface 166, can be shaped or contoured to control segment behavior. For example, the surface 166 can employ an arc G that cooperates with the arc F of the teeth 126,128 and 130 (FIG. 7) to allow the stabilization tabs 160 to control the individual penetration of the teeth 126,128 and 130 (FIG. 7). For instance, if the arcs F and G are generally concentric, then each tooth can have roughly the same depth of penetration. Also, the centers of the arcs F and G can be offset to allow one or more teeth to have more or less depth penetration than other adjacent teeth. The curvature of teeth, and the associated advantages, has already been discussed in reference to FIGS. 1- 3. Additionally, the surface 166 can be positioned radially relative to the teeth 126,128 and 130 (FIG. 7) to permit only a predetermined amount of penetration of the teeth 126,128 and 130 (FIG. 7) into the surface of the spigot end. Moreover, protuberances, such as lands or raised elements, on the surface 166 can also be used to control the depth of penetration of the teeth 126,128 and 130 (FIG. 7).

In other embodiments, the stabilization element can be formed as a groove or valley formed in the segment that receives a portion of the gasket body such as in a tongue-in-groove fashion. In still other embodiments, the segments do not utilize stabilization elements. In such embodiments, an adhesive may be used to retain the segments within the gasket body or a mechanical device such as a strap can be used as a retaining device or the segment can have a sufficiently sized mismatch with the pocket (i.e., an interfering fit that allows the body to compressively retain the segment).

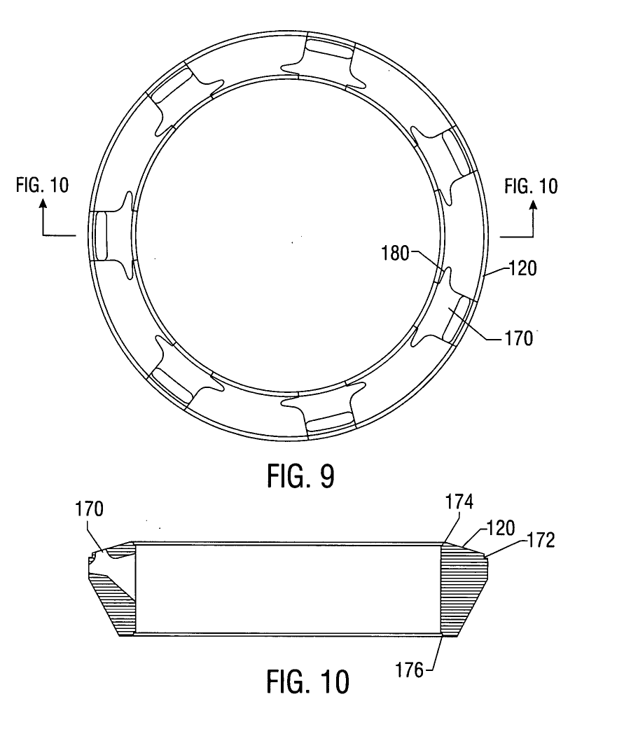

Referring now to FIG. 9, there is shown one embodiment of a gasket body 120 for providing a seal for the joint. In one embodiment, the segments 122 are seated within pockets 170 formed in the body 120. For example, the body 120 can be molded such that the pockets 124 are pre-formed in a shape complementary to the shape of the segments 122. The pockets 124 can be sized have interference fit, a close fit or a fit with a preset amount of “play” with a segment 122 or with a section or portion of the segment 122 such as the stabilization tabs 160. In some embodiments, the segments 122 are sufficiently captured within the pocket 170 that no other retention device is needed. In other embodiments, an adhesive, cap, closure or other device can be used to secure the segment 122 in the pocket 124. It will be appreciated that installing segments 122 into pre-formed pockets 124 provides a number of advantages, including but not limited ot: (i) broken or defective segments can be replaced; (ii) one gasket body can be configured to accept segments of different sizes and thereby extend the range of use for such a gasket body, and (iii) segments of different shapes, materials, or sizes can be inserted into one gasket body to customize or “tune” a gasket for a particular application. Moreover, the gasket body can be used without any segments or with “blanks” (e.g., segments designed merely to fill the space of the pocket). Indeed, in certain applications, sensors can be fitted into the pockets to measure gasket behavior and provide information as to the condition of the seal.

Referring now to FIGS. 6-9, in embodiments where the segment 122 includes protruding stabilization elements 160, the pre-formed pocket 124 can include a portion of material that separates the elements from the outer surface of the spigot end 114 (FIG. 6). This material underlying the stabilization elements forms a resilient layer 180 that can control the penetration of the teeth 126, 128 and 130 into the spigot end 114. In embodiments where the underlying material in relatively incompressible, such as rubber, the stabilization elements 160 and the resilient layer 180 cooperate to act as a buffer or biasing element that moderates or regulates the penetrating action of the teeth 126,128 and 130. Thus, tooth penetration can be controlled by, for example, increasing or decreasing the volume of material making up the resilient layer 180 or by the surface area of the stabilization elements 160 in compressive contact with the resilient layer 180; e.g., decreasing the material volume will reduce the biasing effect.

In other embodiments, the segments 122 can be vulcanized into the gasket or embedded into the gasket by bonding, encapsulation, over-molding, mechanical cooperation, or by one of many other suitable methods. The number of segments 122 inserted into the gasket 100 can vary depending upon the anticipated fluid pressure at the joint and the size of the pipes involved. The segments 122 can be suitably machined, investment cast, extruded, forged, or by other suitable manufacturing methods. The gasket body also includes one or more extrusion reliefs 172 that reduce the amount of gasket material that extrude between gaps separating the socket end and the spigot end, such as gap 153, when the gland compresses the gasket body.

In another aspect of the present invention, an inner surface of an inner diameter of a gasket is formed to have an interference fit with a pipe or spigot end. In one arrangement, the inner diameter is frustoconical in shape (i.e., the inner surface is inclined such that the inner surface is not parallel with the pipe or spigot end. Thus, the gasket inner surface is made to conform with the contours of the pipe and/or socket during assembly. Additionally, the interference fit can be configured to position embedded restraining elements properly as the gasket inner surface conforms to the contours of the pipe and/or socket. The frustoconical shape can be tapered in either axial direction. Moreover, the conical surface have major and minor diameters can be selected to be above or the nominal pipe diameter to control the magnitude and/or nature of the interference fit between the gasket and the pipe and/or spigot end.

In another aspect of the present invention, some embodiments of the gasket according to the present invention have a durometer rubber hardness in the range of 60-70 Shore-A. This narrow range of gasket hardness combined with the use of embedded gripping segments provides the gasket with the ability to apply increased pressure against a back side of the segment during assembly as compared to traditional harder and softer rubber compounds. Harder rubber in the same application requires higher torque to achieve biting force against the gripping segment and may not provide an adequate sealing force of the gasket. Softer rubber extrudes around the edges of the gland and pipe and prevents development of adequate sealing force while initial bite force against the back side of the segment is also compromised. The featured range of durometer hardness accomplishes both initial bite forces applied against the back side of the segment while maintaining appropriate sealing forces in the socket.

Further, whereas the present invention has been described with respect to specific embodiments thereof, it should be understood that the invention is not limited thereto as many modifications thereof may be made. It is, therefore, contemplated to cover by the present application any and all such modifications as fall within the true spirit and scope of the appended claims.

1. An apparatus for use in a joint formed between a first tubular having a socket end and a second tubular having a spigot end, the apparatus comprising:
(a) a resilient annular member having a sealing portion for forming a seal between the first tubular and the second tubular upon being compressed by a gland connected to the socket end; and
(b) at least one gripping element received in the resilient member, the gripping element having:
(i) a plurality of teeth projecting radially inward toward the spigot end for gripping an outer surface of the spigot end; and
(ii) a blunt nose extending axially forward toward the socket end for contacting a front wall of the gland, the blunt nose adapted to contact and roll along the front wall during relative movement between the first and second tubular.

2. The apparatus of claim (1) wherein the gripping element seats within a pocket that is pre-formed in the annular member.

3. The apparatus of claim (2) wherein the gripping element includes a stabilization element shaped to be secured in the pre-formed pocket to thereby secure the gripping element in the annular member.

4. The apparatus of claim (1) wherein the gripping element includes at least one recess into which a material forming the annular member can flow when compressed.

5. The apparatus of claim (1) wherein the blunt nose includes a roughened surface for increasing the frictional contact between the blunt nose and the front wall, the roughened surface including one of: (i) an irregular surface formed by grit blasting, (ii) chemical etches, (iii) spline protrusions, (iv) knurled protrusions, (v) impregnated grit, (vi) composite constructions, (vii) bonded elements, and (viii) coated elements.

6. The apparatus of claim (1) wherein the plurality of teeth arranged includes at least four teeth arranged such that no more than two teeth grip the outer surface of the spigot end when the spigot end is inserted into the socket end.

7. The apparatus of claim (1) wherein at least three of the at least four teeth lie along a common arc.

8. The apparatus of claim (1) wherein the gripping element includes a knob extending radially outwardly from the gripping element, the knob positioned to limit the movement of the blunt nose along the front wall.

9. A method for joining a first tubular having a socket end with a second tubular having a spigot end, comprising:
(a) forming a seal between the first tubular and the second tubular with at least a portion of a resilient annular member by compressing a resilient body against the first and second tubular with a gland having a front wall;
(b) positioning at least one gripping element in the resilient member, the gripping element having a plurality of teeth projecting radially inward toward the spigot end for gripping an outer surface of the spigot end, and a blunt nose extending axially forward toward the socket end for contacting the front wall of the gland, the blunt nose adapted to contact and roll along the front wall during relative movement between the first and second tubular.

10. The method of claim (9) further comprising roughening a surface of the blunt nose to increase the frictional contact between the blunt nose and the front wall.

11. The method of claim (9) further comprising arranging at least four teeth of the plurality of teeth arranged such that no more than two teeth grip the outer surface of the spigot end when the spigot end is inserted into the socket end.

12. The method of claim (9) further comprising limiting the movement of the blunt nose along the front face using a knob formed on the gripping element.

13. The method of claim (9) further comprising forming a pocket in annular member for receiving the gripping element; and securing the gripping element in the pocket using a stabilization element formed on the gripping element.

14. A gasket for mating a first pipe having a socket end with a second pipe having a spigot end, comprising:
(a) an annular body formed of a resilient material, the annular body having a central opening allowing the spigot end to enter therethrough and adapted to deform when acted upon by a gland having a front wall;
(b) a plurality of inserts positioned in the annular body, each the insert having:
(i) a plurality of teeth projecting radially inward toward the spigot end for gripping an outer surface of the spigot end; and
(ii) a blunt nose extending axially forward toward the socket end for contacting the front wall of the gland, the blunt nose adapted to contact and roll along the front wall during relative movement between the first and second tubular.

15. The gasket according to claim (14) wherein the blunt nose includes a roughened surface for increasing the frictional contact between the blunt nose and the front wall.

16. The gasket according to claim (14) wherein the plurality of teeth arranged includes at least four teeth arranged such that no more than two teeth grip the outer surface of the spigot end when the spigot end is inserted into the socket end.

17. The gasket according to claim (14) wherein each gripping element includes a radially outward extending knob, each knob positioned engage the socket end and thereby limit the movement of the blunt nose along the front face.

18. The gasket according to claim (14) wherein each gripping element seats within a pocket that is pre-formed in the annular body.

19. The gasket according to claim (14) wherein each gripping element includes a stabilization element shaped to be secured in the pre-formed pocket to thereby secure the gripping element in the annular body.

20. The gasket according to claim (14) wherein each gripping element includes at least one recess into which a material forming the annular body can flow when compressed.
